(19) United States
(12) Patent Application Publication
(10) Pub. No.: US 2024/0107061 A1
(43) Pub. Date: Mar. 28, 2024

(54) DATA TRANSMISSION METHOD, COMPUTING EQUIPMENT, AND STORAGE MEDIUM

(71) Applicant: Beijing Tusen Zhitu Technology Co., Ltd., Beijing (CN)

(72) Inventors: Pingyuan JI, Beijing (CN); Shengjie GUO, Beijing (CN); Shanxin QU, Beijing (CN)

(21) Appl. No.: 18/470,756

(22) Filed: Sep. 20, 2023

(30) Foreign Application Priority Data
Sep. 26, 2022 (CN) 202211174285.1

(51) Int. Cl. H04N 19/59; H04N 19/176; H04N 19/61

(52) U.S. Cl. CPC H04N 19/59; H04N 19/176; H04N 19/61

(57) ABSTRACT

The present document relates to a data transmission method, computing equipment, and a storage medium, adapted to be executed in first computing equipment. The data transmission method includes: compressing original images collected by an image collection device to obtain compressed images; packaging one of the compressed image into at least one data packet each including a protocol head and a data segment; sending the at least one data packet to a second computing equipment, so that the second computing equipment determines a resolution corresponding to the image collection device according to scenario information of a scenario where the original images are collected; and in response to the determined resolution being equal or less than a threshold, setting a data segment of a data packet of the other ones of the compressed images corresponding to the image collection device to be null.

The present document claims priority to Chinese patent application No. 202211174285.1, titled “DATA TRANSMISSION METHOD, COMPUTING EQUIPMENT, AND STORAGE MEDIUM”, filed on Sep. 26, 2022, the content of which is incorporated herein by reference in its entirety.

### TECHNICAL FIELD

The present document relates to the technical field of image processing, in particular to a data transmission method, computing equipment, and storage medium.

### BACKGROUND

The rapid development of autonomous driving technology is highly dependent on full-angle coverage and redundantly designed sensors, such as cameras, LIDARs, and millimeter-wave radars, which not only improve the security of autonomous driving, but also greatly increase the amount of data transmission, thereby increasing the transmission load of network cards and consuming great server resources. Therefore, how to improve the data transmission efficiency of autonomous driving vehicles on the premise of ensuring the safety of autonomous driving becomes an urgent problem to be solved.

### SUMMARY

Therefore, the present document provides a data transmission method, a device, computing equipment, and a storage medium to solve or at least solve the aforementioned problems.

The first aspect of the embodiments of the present document provides a data transmission method adapted to be executed in first computing equipment, the first computing equipment being communicatively connected to an image collection device and second computing equipment, respectively, and the method comprising:
acquiring an original image collected by the image collection device;
compressing the original image to obtain a compressed image;
packaging the compressed image into at least one data packet comprising a protocol head and a data segment;
sending at least one data packet to the second computing equipment so that the second computing equipment computes a resolution of a subsequent compressed image corresponding to the image collection device according to scenario information about a collected original image; and
in response to the resolution being zero, setting a data segment of a data packet of the image collection device to be transmitted subsequently to be null.

The second aspect of the embodiments of the present document provides a data transmission method adapted to be executed in second computing equipment, the second computing equipment being communicatively connected to first computing equipment, the first computing equipment being communicatively connected to an image collection device, and the method comprising:
receiving a data packet sent by the first computing equipment, wherein the data packet is formed by a compressed image package, and the compressed image is obtained by compressing an original image collected by the image collection device;
identifying a resolution of a subsequent compressed image corresponding to the image collection device according to scenario information when the original image is collected; and
in response to the resolution being zero, sending a cut-off instruction to the first computing equipment so that the first computing equipment sets a data segment of a data packet of the image collection device to be transmitted subsequently to be null

The third aspect of the embodiments of the present document provides first computing equipment, comprising:
a first receiving module adapted to receive an original image collected by an image collection device;
a first processing module adapted to compress the original image to obtain a compressed image, and package the compressed image into at least one data packet, wherein the data packet comprises a protocol head and a data segment; and
a data sending module adapted to send at least one data packet to second computing equipment communicatively connected to the first computing equipment, so that the second computing equipment computes a resolution of a subsequent compressed image corresponding to the image collection device according to scenario information about a collected original image;
wherein the first processing module is further adapted to set a data segment of a data packet corresponding to the image collection device to be transmitted subsequently to be null in response to the resolution being zero.

The fourth aspect of the embodiments of the present document provides second computing equipment, comprising:
a second receiving module adapted to receive a data packet sent by first computing equipment, wherein the data packet is formed by a compressed image package, and the compressed image is obtained by compressing an original image collected by an image collection device;
a second processing module adapted to process the compressed image into a format required by an algorithm;
an algorithm module adapted to determine a resolution of a subsequent compressed image corresponding to the image collection device according to scenario information of a scenario when the original image is collected; and
a second control module adapted to send a cut-off instruction to the first computing equipment in response to the resolution being zero, so that the first computing equipment sets a data segment of a data packet of the image collection device to be transmitted subsequently to be null.

The fifth aspect of the embodiments of the present document provides computing equipment including one or more processors; and a memory storing one or more programs that, when executed by the one or more processors, cause the one or more processors to implement the data transmission method according to the present document.

The sixth aspect of the embodiments of the present document provides a computer-readable storage medium having stored thereon a program which, when executed by a processor, implements the data transmission method according to the present document.

According to the technical solutions of the present document, under a specific scenario, with regard to some unnecessary image collection devices, the image collection devices are not turned off such that frequent turning on and off are avoided which would otherwise affect the data transmission efficiency. The image collection devices are kept to normally collect data, and first computing equipment, as one piece of data transfer equipment, also normally receives original images collected by the image collection devices. However, when the first computing equipment forwards the image data to second computing equipment such as a server, the text of the data segment in the data packet is set to be null, namely, null data is transmitted to the second computing equipment. In this way, the normal image collection and transmission frequency can be maintained, the phenomenon of frame loss and frame error due to misjudgments can be prevented, the data transmission volume can also be reduced and the network bandwidth can be saved.

Furthermore, the first computing equipment of the present document, with a first frequency, triggers the image collection device to collect an image at that time, and at the same time, with a second frequency, performs frame extraction on the received image sequence, namely, discards part of the frames with the second frequency, so as to not only ensure a good camera exposure effect, but also reduce the amount of data to be transmitted.

### BRIEF DESCRIPTION OF THE DRAWINGS

In order to illustrate the embodiments of the present document or the technical solutions in the prior art more clearly, the following will briefly introduce the drawings that need to be used in the description of the embodiments or the prior art. Obviously, for those of ordinary skills in the art, other drawings can be obtained according to these drawings without involving inventive efforts.

FIG. 1 is a schematic diagram of a vehicle 100 in which various technologies disclosed herein can be implemented.

FIG. 2 shows a structural diagram of a data transmission system 200 according to one embodiment of the present document.

FIG. 3 shows a structural diagram of a data transmission system 200 according to another embodiment of the present document.

FIG. 4 shows a flowchart of a data transmission method 400 according to one embodiment of the present document.

FIG. 5 shows a flowchart of a data transmission method 500 according to another embodiment of the present document.

FIG. 6 shows a flowchart of a data transmission method according to another embodiment of the present document.

FIG. 7 shows a schematic diagram of the process of image data change according to one embodiment of the present document.

FIG. 8 shows a structural diagram of computing equipment 800 according to one embodiment of the present document.

### DETAILED DESCRIPTION

The technical solutions in the embodiments of the present document will be clearly and completely described below in conjunction with the accompanying drawings. Obviously, the described embodiments are only a part of the embodiments of the present document, rather than all the embodiments. Various modifications and changes may be made by those skilled in the art based on the embodiments described herein, and all technical solutions obtained through equivalent mode transformation fall within the scope of protection of this document.

In order to facilitate a clear description of the technical solutions of the embodiments of the present document, in the embodiments of the present document, the words “first”, “second”, etc. are to distinguish the same or similar items having substantially the same function or action, and those skilled in the art could understand that the words “first”, “second”, etc. do not limit the number or order of execution.

The term “and/or” used herein is merely an association relationship describing an associated object, meaning that there may be three relationships, for example, A and/or B, which may mean: three cases of A existing individually, both A and B existing, and B existing individually. In addition, the character “I” herein generally indicates that the associated object is an “or” relationship.

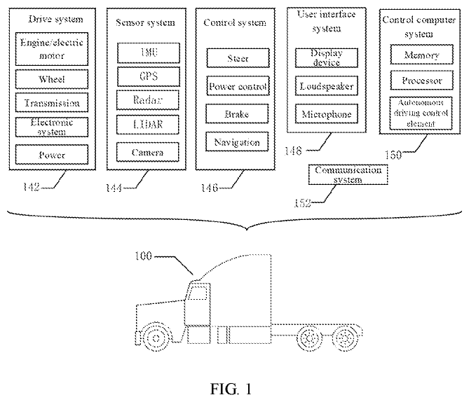

FIG. 1 is a schematic diagram of a vehicle 100 that can be virtualized in simulation equipment in which the present document can be implemented. The vehicle 100 may be a car, a truck, a motorcycle, a bus, a boat, an airplane, a helicopter, a lawn mower, an excavator, a snowmobile, an aircraft, a recreational vehicle, an amusement park vehicle, a farm device, a construction device, a tram, a golf cart, a train, a trolley bus, or other vehicles. The vehicle 100 may be fully or partially operated in an autonomous driving mode. The vehicle 100 may control itself in the autonomous driving mode, e.g., the vehicle 100 may determine the current state of the vehicle and the current state of an environment in which the vehicle is located, determine a predicted behavior of at least one other vehicle in the environment, determine a level of trust corresponding to a possibility that the at least one other vehicle will execute the predicted behavior, and control the vehicle 100 itself based on the determined information. While in autonomous driving mode, the vehicle 100 may operate without human interaction.

The vehicle 100 may include various vehicle systems such as a drive system 142, a sensor system 144, a control system 146, a user interface system 148, a control computer system 150, and a communication system 152. The vehicle 100 may include more or fewer systems, each of which may include a plurality of units. Further, each system and unit of the vehicle 100 may be interconnected. For example, the control computer system 150 can be in data communication with one or more of systems 142-148 and 152. Therefore, one or more of the described functions of the vehicle 100 may be divided into additional functional or physical components, or combined into a fewer number of functional or physical components. In a further example, additional functional or physical components may be added to the example shown in FIG. 1.

The drive system 142 may include a plurality of operable components (or units) that provide kinetic energy to the vehicle 100. In one embodiment, the drive system 142 may include an engine or an electric motor, wheels, a transmission, an electronic system, and a power (or a power source). The engine or electric motor may be any combination of the following devices: an internal combustion engine, an electric motor, a steam engine, a fuel cell engine, a propane engine, or other forms of engines or electric motors. In some embodiments, the engine may convert a power source into mechanical energy. In some embodiments, the drive system 142 may include a plurality of engines or electric motors. For example, a gasoline-electric hybrid vehicle may include a gasoline engine and electric motor, among other things.

The wheel of the vehicle 100 may be a standard wheel. The wheel of the vehicle 100 may be any of a variety of types of wheels, including one-wheel, two-wheel, three-wheel, or four-wheel types, such as four-wheel on a car or a truck. Other numbers of wheels are also possible, for example, six wheels or more. One or more wheels of the vehicle 100 may be operated in a different direction of rotation from the other wheels. The wheel may be at least one wheel fixedly connected to the transmission. The wheel may comprise a combination of metal and rubber, or a combination of other substances. The transmission may include a unit operable to transmit the mechanical power of the engine to the wheel. For this purpose, the transmission may comprise a gearbox, a clutch, a differential gear, and a propeller shaft. The transmission may also comprise other units. The propeller shaft may include one or more axles matching the wheel. The electronic system may include a unit for transmitting or controlling an electronic signal of the vehicle 100. These electronic signals may be configured to activate a plurality of lights, servo mechanisms, electric motors, and other electronic driving or control devices in the vehicle 100. The power source may be an energy source that wholly or partially powers the engine or the electric motor. That is, the engine or the electric motor can convert the power source into mechanical energy. Illustratively, the power source may include gasoline, petroleum, petroleum fuels, propane, other compressed gaseous fuels, ethanol, fuel cells, solar panels, batteries, and other electrical energy sources. The power source may additionally or alternatively include any combination of a fuel tank, a battery, a capacitor, or a flywheel. The power source may also provide energy to other systems of the vehicle 100.

The sensor system 144 may include a plurality of sensors for sensing information about the environment and conditions of the vehicle 100. For example, the sensor system 144 may include an inertial measurement unit (IMU), a global positioning system (GPS) transceiver, a radar (such as millimeter wave radar RADAR) unit, a laser rangefinder/LIDAR unit (or other distance measurement devices), an acoustic sensor, and a camera or an image collection device. The sensor system 144 may include a plurality of sensors for monitoring the vehicle 100 (e. g., an oxygen monitor, a fuel gauge sensor, an engine oil pressure sensor, etc.). The sensor system 144 may also be configured with other sensors. One or more sensors included in the sensor system 144 may be individually driven or collectively driven to update the position or direction, or both of one or more sensors.

In some embodiments, each sensor collects data through hardware triggering or software triggering, with different sensors having different triggering frequencies, i.e., different data collection frequencies correspondingly have different data collection periods. For hardware triggering, the triggering source uses the pulse per second signal sent by the Novatel as the triggering source signal, makes adjustments according to the required trigger frequency of different sensors, and generates a trigger signal and sends the same to the corresponding sensor, so as to trigger the corresponding sensor to collect data. Alternatively, the trigger frequency of a camera is 20 HZ, the trigger frequency of a LIDAR is 1 HZ or 10 HZ, and the trigger frequency of an IMU is 100 HZ, although it is not limited thereto.

The IMU may include a combination of sensors (e.g., an accelerator and a gyroscope) for inducing positional and directional changes of the vehicle 100 based on inertial acceleration. The GPS transceiver may be any sensor configured to estimate the geographic location of the vehicle 100. For this purpose, the GPS transceiver may include a receiver/transmitter to provide the position information of the vehicle 100 relative to the earth. It needs to be noted that GPS is one example of a global navigation satellite system, and therefore, in some embodiments, the GPS transceiver may be replaced with a BeiDou navigation satellite system transceiver or a Galileo satellite navigation system transceiver. The radar unit may use radio signals to sense an object in the environment of the vehicle 100. In some embodiments, in addition to inducing an object, the radar unit may also be configured to sense the speed and heading of an object approaching the vehicle 100. The laser range finder or LIDAR unit (or other distance measuring devices) may be any sensor that uses a laser to sense an object in the environment of the vehicle 100. In one embodiment, the laser range finder/LIDAR unit may include a laser source, a laser scanner, and a detector. The laser range finder/LIDAR unit is configured to operate in either a continuous (e.g., using heterodyne detection) or discontinuous detection mode. The camera may include a device for capturing a plurality of images of the environment in which the vehicle 100 is located. The camera may be a still image camera or a dynamic video camera.

The control system 146 is configured to control the operation of the vehicle 100 and the components (or units) thereof. Correspondingly, the control system 146 may include various units, such as a steering unit, a power control unit, a braking unit, and a navigation unit.

The steering unit may be a combination of machines that adjust the forward direction of the vehicle 100. The power control unit (which may be, for example, an accelerator) may be configured, for example, to control the operating speed of the engine and thus the speed of the vehicle 100. The braking unit may include a combination of machines for decelerating the vehicle 100. The brake unit can decelerate the vehicle with frictional force in a standard manner. In other embodiments, the braking unit may convert the kinetic energy of the wheel into electrical current. The brake unit may also take other forms. The navigation unit may be any system that determines a driving path or route for the vehicle 100. The navigation unit may also dynamically update the driving path during the travel of the vehicle 100. The control system 146 may additionally or alternatively include other components (or units) not shown or described.

The user interface system 148 may be configured to allow the interaction between the vehicle 100 and external sensors, other vehicles, other computer systems, and/or a user of the vehicle 100. For example, the user interface system 148 may include a standard visual display device (e.g., a plasma display, a liquid crystal display (LCD), a touch screen display, a head-mounted display, or other similar displays), a loudspeaker or other audio output devices, a microphone or other audio input devices. For example, the user interface system 148 may also include a navigation interface, and an interface that controls the internal environment (e.g., the temperature, fan, etc.) of the vehicle 100.

The communication system 152 may provide a way for the vehicle 100 to communicate with one or more equipment or other surrounding vehicles. In one exemplary embodiment, the communication system 152 may communicate with one or more equipment directly or through a communication network. The communication system 152 may be, for example, a wireless communication system. For example, the communication system can use 3G cellular communication (such as CDMA, EVDO, GSM/GPRS) or 4G cellular communication (such as WiMAX or LTE), as well as 5G cellular communication. Alternatively, the communication system may communicate with a wireless local area network (WLAN). In some embodiments, the communication system 152 may communicate directly with one or more pieces of equipment or other surrounding vehicles, for example, by using infrared ray, Bluetooth, or ZIGBEE. Other wireless protocols, such as various vehicle-mounted communication systems, are also within the scope disclosed in the present document. For example, the communication system may include one or more dedicated short-range communication (DSRC) devices, V2V devices, or V2X devices that communicate publicly or privately data with vehicles and/or roadside stations.

The control computer system 150 can control some or all functions of the vehicle 100. The autonomous driving control unit in the control computer system 150 may be configured to identify, evaluate, and avoid or go over potential obstacles in the environment in which the vehicle 100 is located. In general, the autonomous driving control unit may be configured to control the vehicle 100 without a driver, or to provide assistance for the driver to control the vehicle. In some embodiments, the autonomous driving control unit is configured to combine data from GPS transceivers, radar data, LIDAR data, camera data, and data from other vehicle systems to determine the driving path or trajectory of the vehicle 100. The autonomous driving control unit may be activated to enable the vehicle 100 to be driven in an autonomous driving mode.

The control computer system 150 may include at least one processor (which may include at least one microprocessor), which executes processing instructions (i.e., machine-executable instructions) stored in non-volatile computer-readable media (such as data storage devices or memory). The memory stores therein at least one machine-executable instruction. The implementation of the processor executing at least one machine-executable instruction includes functions such as a map engine, a positioning module, a perception module, a navigation or path module, and an automatic control module. A map engine and a positioning module are configured to provide map information and positioning information. The perception module is configured for perceiving things in the environment where the vehicle is located according to the information acquired by the sensor system and the map information provided by the map engine. The navigation or path module is configured for planning a driving path for the vehicle according to the processing results of the map engine, the positioning module, and the perception module. The automatic control module parses and converts the decision information input of modules such as the navigation or path module into a control command output for the vehicle control system, and sends the control command to a corresponding component in the vehicle control system via a vehicular network (for example, a vehicle internal electronic network system realized by means of a CAN bus, a local interconnect network, a multimedia directional system transmission, etc.) so as to realize automatic control of the vehicle; the automatic control module may also acquire the information of various components in the vehicle via the vehicular network.

The control computer system 150 may also be a plurality of pieces of computing equipment that control components or systems of the vehicle 100 in a distributed manner. In some embodiments, the memory may contain therein processing instructions (e.g., program logic) that are executed by the processor to perform various functions of the vehicle 100. In one embodiment, the control computer system 150 is capable of data communication with systems 142, 144, 146, 148, and/or 152. An interface in the control computer system is configured to facilitate data communication between the control computer system 150 and the systems 142, 144, 146, 148, and 152.

The memory can also include other instructions, including instructions for data sending, instructions for data reception, instructions for interactions, or instructions for controlling the drive system 142, the sensor system 144, or the control system 146 or the user interface system 148.

In addition to storing processing instructions, the memory may store a variety of information or data, such as image processing parameter, road map, and path information. Such information may be used by the vehicle 100 and the control computer system 150 during the operation of the vehicle 100 in an automatic, semi-automatic, and/or manual mode.

Although the autonomous driving control unit is shown to be separate from the processor and memory, it should be understood that in some implementation modes, some or all functions of the autonomous driving control unit can be implemented by using program code instructions set in one or more memories (or data storage devices) and executed by one or more processors. In some cases, the autonomous driving control unit can be implemented by using the same processor and/or memory (or data storage device). In some implementation modes, the autonomous driving control unit may be implemented at least in part by using various dedicated circuit logics, various processors, various field programmable gate arrays (FPGA), various application-specific integrated circuits (ASIC), various real-time controllers and hardware.

The control computer system 150 may control the functions of the vehicle 100 according to inputs received from various vehicle systems (e.g., the drive system 142, the sensor system 144, and the control system 146), or from the user interface system 148. For example, the control computer system 150 can use inputs from the control system 146 to control the steering unit to avoid obstacles detected by the sensor system 144. In one embodiment, the control computer system 150 may be configured to control various aspects of the vehicle 100 and a system thereof.

Although FIG. 1 shows various components (or units) integrated into vehicle 100, one or more of these components (or units) may be mounted on vehicle 100 or individually associated with vehicle 100. For example, the control computer system 150 may exist partially or completely independent of the vehicle 100. Therefore, the vehicle 100 can exist as a separate or integrated unit of the equipment. The equipment units constituting the vehicle 105 may communicate with each other by wire communication or wireless communication. In some embodiments, additional components or units may be added to each system or one or more of the above components or units may be removed from the system (e.g., the LiDAR or radar shown in FIG. 1).

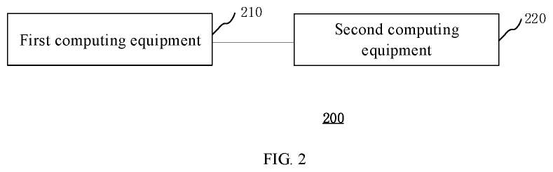

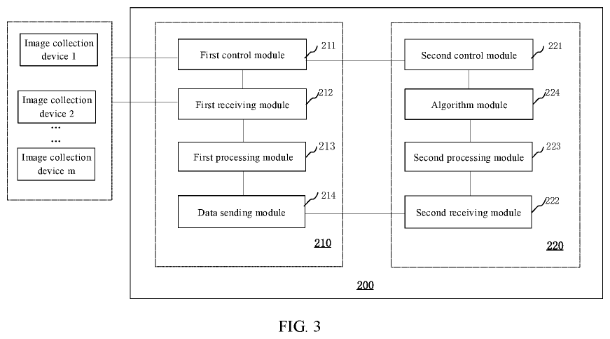

In some embodiments, the control computer system 150 may include a data transmission system 200 as shown in FIG. 2. The data transmission system 200 includes first computing equipment 210 and second computing equipment 220. As shown in FIG. 3, the first computing equipment 210 includes at least one of the first control module 211, the first receiving module 212, the first processing module 213, or the data sending module 214. The second computing equipment 220 includes at least one of the second control module 221, the second receiving module 222, the second processing module 223, or an algorithm module 224. Among other things, the algorithm module 224 may implement the execution logic of an autonomous driving control unit in the control computer system 150.

The first computing equipment 210 receives sensor data collected by a sensor, such as receiving an original image collected by an image collection device such as a camera, compresses the received original image, and then sends the compressed image to the second computing equipment 220. The second computing equipment 220 decompresses the received data such that the algorithm module 224 performs computations based on the decompressed data. The first computing equipment 210 and the second computing equipment 220 may be two independent pieces of equipment. For example, the first computing equipment 210 is data relay equipment such as a switch. The second computing equipment 220 is a vehicular domain controller, which integrates the functions of a vehicular server. As another example, the first computing equipment 210 is a vehicular domain controller and the second computing equipment 220 is a vehicular server.

In some embodiments, the first control module 211 configures parameters of each image collection device including, but not limited to, image acquisition frame rate, output format, exposure time, and gain. The first control module 211 may dynamically adjust various parameters of the image collection device according to changes in the environment in which the image collection device or the vehicle is located.

A serializer and deserializer are used between the image collection device and the first receiving module 212 to complete the transmission of the image data, and the deserializer of the first receiving module 212 receives the serializer data of the image collection device via an MIPI hardware interface. Alternatively, the first receiving module 212 notifies the first processing module 213 to perform data compression after receiving one complete frame of the Bayer image, or notifies the first processing module 213 to perform compression on s row of data after receiving the s row of data.

The first processing module 213 performs data conversion on the Bayer data, and successively converts the Bayer data into YUV444 format data, down-sampling, block division (performing dividing according to a pixel area), DCT (Discrete Cosine Transform), quantization (dividing each coefficient obtained after DCT by a corresponding value in a quantization matrix, and then performing rounding), and Huffman coding, etc. so as to obtain complete JPEG (Joint Photographic Experts Group) data. These image processing procedures may be performed in a manner that is relatively conventional in the art and will not be described in detail herein.

The data sending module 214 performs data package on the JPEG data generated by the first processing module 213 and sends the packaged data packet to the second receiving module 222. Data transmission protocols use proprietary protocols to improve data stability and reliability. For example, UDP (User Datagram Protocol) or Transmission Control Protocol can be used. Depending on the JPEG data size, data subpackage may be involved, i.e., one frame of JPEG data is packaged into n data packets, n being an integer greater than or equal to 1. For example, each row of data may be packaged into one data packet, with each packet including a protocol head and a data segment. In addition, each data packet includes a sending time stamp, a data packet sequence number, a frame identification, and a line identification. These identifications may be stored in the protocol head. A data packet sequence number represents that the data packet is the number of the packet in one frame of a JPEG image, a frame identification represents the frame identification of the JPEG image corresponding to the data packet, each frame of a JPEG image has a unique frame identification, and a plurality of data packets packaged based on the JPEG image also carry the frame identification of the JPEG image. The row identification represents which rows of pixels the data packet is packaged from.

The data transferred by the data sending module 214 to the second receiving module 222 also includes the total number of data packets, i.e., n. The second receiving module 222 determines whether one frame of an image is completely received according to the received total number n and the data packet identification in each data packet. The second receiving module 222 may determine that the frame data has been completely transmitted according to the frame end of the last data packet of each frame of JPEG data, and then start transmitting the data packet of the next frame of the image. If it is determined that the total number of data packets of the received frame is less than n when the frame end is received, it represents that a frame loss occurs.

When all the data packets of one frame of the image have been received, the second processing module 223 decompresses the received data. Optionally, the second receiving module notifies the second processing module 223 to perform a decompression operation after receiving the first p data packets of n data packets, p being an integer less than n. For example, if one frame of JPEG image is packaged into 10 data packets, after receiving the first three data packets, the decompression operation can be executed.

In some embodiments, the step of the second processing module 223 decompressing the data comprises: subjecting the received JPEG data to the steps of Huffman decoding, inverse quantization, DCT inverse transformation, color rendition YUV444, BGR conversion, etc. The decompressed data is sent to the algorithm module 224 for computing, and the algorithm module runs on the vehicle end, and thus can be referred to as an on-line algorithm module. Correspondingly, the module for training the algorithm model off-line may be referred to as an off-line algorithm module. Algorithm modules include, but are not limited to, a perceiving algorithm module, a positioning algorithm module, a planning algorithm module, and a control algorithm module. The four modules are configured for road and environment perceiving vehicle and sensor positioning, path planning, and executing control operations, respectively.

Furthermore, the image collection device may be a plurality of image collection devices (e.g., image collection devices 1-m). The document pre-configures the resolution of compressed images transmitted by the first computing equipment 210 to different image collection devices in different scenarios in advance. The algorithm module 224 can determine the image resolution (the image resolution can also be called the determined solution) to be adjusted according to the scenario information and turn on the cutoff function, adjust the resolution of the compressed image or the original image corresponding to a specific camera under a specific scenario, or notify the first computing equipment to transmit null data under the specific scenario, so as to minimize the resource occupation, improve the data processing speed, and ensure the safe operation of autonomous driving.

The algorithm module 224 computes the image resolution, and sends a resolution adjusting instruction to the second control module 221. The instruction carries the determined resolution.

In one implementation mode, a message comprising the image resolution determined by the algorithm module 224 is sent by the second control module 221 to the first computing equipment 210 so that the first computing equipment adjusts the resolution of the compressed image to be subsequently transmitted. The second control module 221 sends a resolution adjusting instruction to the first computing equipment 210, the resolution adjusting instruction carrying the resolution determined by the algorithm module 224. In response to the resolution being zero, the first computing equipment 210 sets a data segment of a data packet to be transmitted subsequently to be null; in response to the resolution not being zero, the first computing equipment 210 adjusts the resolution of the corresponding compressed image to be transmitted accordingly, i.e., the resolution is adjusted to be the determined resolution. Alternatively, when the resolution determined by the algorithm module 224 is zero, a cutoff instruction may be sent directly to the first computing equipment 310 so that the first computing equipment sets the data segment of a data packet to be transmitted subsequently to be null. It should be understood that the first computing equipment 310 can also adjust the resolution of the original image to be compressed subsequently corresponding to the image collection device, to obtain an adjusted original image, and compress the adjusted original image into a compressed image.

In another implementation mode, the second control module 221 receives the instruction to reconfigure the width and height parameters of the image and sends the reconfigured parameters to the second processing module so that the second processing module adjusts the resolution of the received compressed data. The algorithm module 224 then performs the calculation based on the data whose resolution has been adjusted, which effectively reduces the amount of data computation.

It should be understood that the algorithm module 224 may also send the determined resolution directly to the second processing module or the first equipment 210, i.e., without forwarding via the second control module 221.

The scenario information of a scenario includes scenario type of a scenario when the original image is collected, or a scenario where the original image is collected, or a scenario where the vehicle or the image collecting device or the first computing device or the second computing device is located. In some embodiments, the scenario information includes, but is not limited to, at least one of an expressway scenario, a level road scenario, a reversing scenario, an uphill scenario, a port scenario, or a calibration scenario. There can of course also be many other scenarios, each having an optimal image transmission resolution for each camera. The expressway is usually specifically reserved for vehicles and comprises roads between cities, between cities and towns, and between towns. The level road comprises urban road, the urban road comprises at least one of major road, secondary road, branch road, expressway. The maximum speed limit of expressway is larger than that of the level road. The speed limit of the expressway is in a first region, the speed limit of the level road is in a second region, the value of second region is smaller than that of the first region. The calibration scenario is a scenario for calibrating a sensor. For example, a scenario for calibrating a binocular camera, in which case a calibration board may be provided ahead in the scenario, the binocular camera respectively shooting the calibration board, and a calibration algorithm calibrating parameters of the binocular camera according to the shot result. The calibration may also be performed by shooting a lane line in the road during the traveling of the vehicle and comparing the same with the lane line in the map. Calibration scenarios may be configured for the calibration of any sensor, such as a LiDAR, or a millimeter wave radar, which is not limited in the present document.

In one implementation mode, the second computing equipment 220 may subscribe to a Topic from an autonomous driving control unit of the control computer system 150, the Topic maintained by the autonomous driving control unit containing the current scenario information, and the second computing equipment 220 identifying the scenario information from the subscribed Topic. The scenario information may be written into an autonomous driving configuration item, such as a global information item, before the vehicle traveling. At that, the scenario information is stored in the Topic. For example, when the vehicle is to perform the calibration, the scenario information is written in advance as a calibration scenario. Or when the vehicle performs a reverse task, the scenario information is written in advance as a reverse scenario. The scenario information may also be written into the map in advance. At this time, scenario information corresponding to different locations is stored in advance in the map such that when the vehicle drives to different locations, the second computing equipment 220 may determine the corresponding scenario information according to the current map information.

For example, in expressway scenarios, cameras 1-4 use 2k resolution, cameras 5-8 use 4k resolution, and camera 9 uses 0k resolution. However, for a camera needing to transmit a resolution of 0k, the present document does not turn off the corresponding camera, but allows the camera to normally transmit image data to the first computing equipment 210 so as to ensure the normal image acquisition frame rate. When the first computing equipment 210 transmits data to the second computing equipment 220, null data is transmitted, i.e., the data segment of the data packet to be transmitted is set to be null, which can be implemented, for example, by emptying an existing context of the data segment or packaging a compressed image into a packet with a protocol header and an empty data segment. In this way, the data delay and error caused by frequent camera turning-on and turning-off are avoided, and the data transmission amount is reduced to some extent and the data transmission efficiency is improved on the premise of ensuring the safety of an autonomous drive system.

In another implementation mode, the second computing equipment 220 may compute the scenario information more intelligently and in real-time, e.g., the second computing equipment 220 identifying the scenario information based on the pose of the image collection device when collecting an original image. Here, the algorithm module 224 of the second computing equipment 220 acquires, in real time, GPS positioning signals or IMU data of the image collection device when collecting each frame of original images. According to the data, a position where the current vehicle is located can be preliminarily determined. Based on the position, the scenario information where the current vehicle is located can be known. It should be understood that the pose of the image collection device and the vehicle pose can be converted by an offset or conversion matrix, so that it works here when any pose is acquired.

In addition, in consideration of the installation angle and photographing angle of the camera in the vehicle, the second processing module 223 of the second computing equipment 220 may also perform rotation processing on the image according to the pose of the image collection device, such as rotating by 90 degrees, horizontal flipping, vertical flipping, etc. In addition, the second processing module 223 may further scale the received image data.

Further, the algorithm module 224 perceives and locates the received image data, obtains the pose of the image collection device, and further obtains the current scenario information. For example, a lane line in the image is recognized and compared with a map lane line at the current position to obtain the pose of the current vehicle.

In yet another implementation mode, both the compressed image and the data packet carry the scenario information. When receiving the original image, the first computing equipment 210 simultaneously acquires the pose of the image collection device when acquiring the original image, and generates the corresponding scenario information according to the pose The pose is passed down from the original image to the compressed image and the data packet. The scenario information may be added in the protocol head of the data packet. Here, the original image carries an image collection time stamp, and the first computing equipment simultaneously acquires a GPS signal or IMU data corresponding to the time stamp so as to identify the pose of the image collection device.

In yet another implementation mode, both the first computing equipment 210 and the second computing equipment 220 can be communicatively connected to roadside equipment, and the roadside equipment stores scenario information corresponding to a current position, such as a high-speed road scenario, etc. at present. The first computing equipment 210 or the second computing equipment 220 may acquire the current scenario information from the roadside equipment.

In summary, the present document may set a plurality of scenario configurations, each setting a resolution at which the first computing equipment 210 transmits images of different cameras. Further, in addition to proceeding according to the pre-configured scenario information, the second computing equipment 220 may further dynamically adjust the resolutions of different cameras in real-time. Specifically, the algorithm module 224 performs target detection on the images acquired by the cameras on the left side and right side of the vehicle. If the scenario on two sides of the vehicle displayed by the images do not significantly change within a continuous period of time (or within a plurality of continuous frames), the resolutions of the compressed images of the cameras on the left side and right side can be reduced. If the scenarios on two sides of the vehicle is always water area or farmland, most of the images collected by the cameras configured for photographing the left side and right side are water or farmland. Therefore, the resolutions of the compressed images of the cameras on two sides can be reduced, and even the resolutions can be periodically adjusted to 0, so as to realize intermittent cutoff.

Further, considering that a point cloud collected by a point cloud collection device is also forwarded by the first computing equipment 210 to the second computing equipment 220, similarly to the image collection device, in some scenarios, when the first computing equipment forwards the point cloud data of a certain point cloud acquisition apparatus, the point cloud points may also be appropriately pruned, for example, removing a predetermined percentage (such as 10-20%) of the point cloud points in one frame of point cloud, so as to reduce the amount of data transmission.

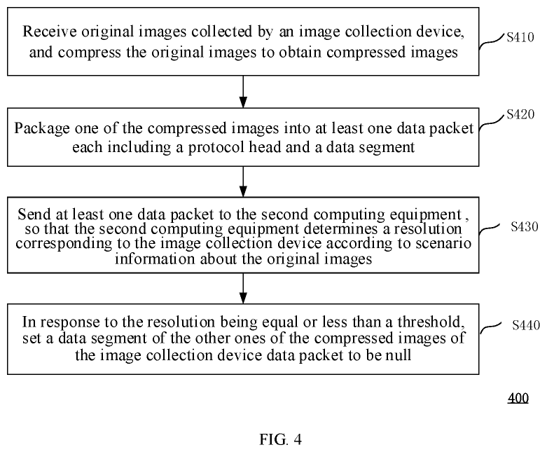

FIG. 4 illustrates a flow diagram of a data transmission method 400, which may be performed in first computing equipment 210, according to one embodiment of the present document. As shown in FIG. 4, the method 400 includes:
step S410, receiving an original image collected by an image collection device, and compressing the original image to obtain a compressed image.

In some embodiments, step S410 further includes: sending a trigger signal to the image collection device to receive the original image collected by the image collection device in response to the trigger signal. Furthermore, the image collection device collects an image at a first frequency, and the first computing equipment receives an image sequence transmitted from the image collection device at the first frequency and performs frame extraction processing on the image sequence at a second frequency to obtain the original image. Extracting a frame can be understood as selecting one frame every P frames, or selecting one frame every predetermined period, and the extracted frame is configured for executing subsequent image compression and transmission operations, and frames not being extracted can be directly discarded. The second frequency is less than the first frequency, the first frequency may be 40-80 Hz, and the second frequency may be 8-20 Hz, although it is not limited thereto.

If the image collection device directly collects data at the second frequency, the transmission delay will be increased, and the transmission delay will be increased by 1000 ms/the second frame rate, thereby increasing the downstream data transmission delay and increasing the system risk. Furthermore, when the output frame rate of the image collection device changes to the second frequency, the jelly effect (when the camera is exposed row by row, due to insufficient scanning speed, the shooting results may appear “tilt”, “sway” or “partial exposure”, etc.), prompt light flickering, low image quality, and like problems will be aggravated. However, the image collection device of the present document collects and transmits data at the first frequency, and the first computing equipment performs frame extraction processing on the image sequence according to the second frequency so that the original image is also transmitted to the second computing equipment at the second frequency, thereby effectively reducing the data transmission delay, effectively reducing the influence of the jelly effect, and improving the image quality.

In step S420, the compressed image is packaged into at least one data packet comprising a protocol head and a data segment. The data segment is a data text to be transmitted, and the protocol head comprises a packet sequence number, a time stamp of an original image, and a frame identification of the original image. Optionally, the protocol head may further include a row number to which the data packet corresponds, such that the second computing equipment identifies one frame of a complete image according to the frame identification and the row number.

In some embodiments, step S420 further comprises: each time a predetermined number of rows of pixels in the compressed image is received, packaging and crating the predetermined number of rows of pixels, the protocol head further comprising a row identification of the rows corresponding to the data packet, so that the second computing equipment identifies the position of the received data packet in one frame of an image according to the frame identification and the row identification.

Step S430, send at least one data packet to the second computing equipment communicatively connected to the first computing equipment, so that the second computing equipment computes a resolution of a subsequent compressed image corresponding to the image collection device according to scenario information about a collected original image. The resolution may comprise 0k, 1k, 2k, 4k, 5k, 8k and so on, which stand for “total column number of image pixels, where “k” is an abbreviation of “kilo”. Each resolution has a corresponding pixels number, and the pixels number can be set as required. For example, the 2k resolution comprises at least one of 1920 pixels×1080 pixels, 1998 pixels×1080 pixels, 2048 pixels×1080 pixels, the 4k resolution comprises 3840 pixels×2160 pixels, 3996 pixels×2160 pixels, 4096 pixels×2160 pixels, the 5k resolution comprises 5120 pixels×2880 pixels, the 8k resolution comprises 7680 pixels×4320 pixels. Each image collection device has a resolution of its corresponding compressed image in different scenarios, and after acquiring scenario information about each frame of an image, the second computing equipment determines the resolution of a compressed image corresponding to each image collection device in the scenario. The second computing device can continuously calculate the resolution based on the scenario information corresponding to each original image and send a message comprising the newly calculated resolution to the first computing device. In some embodiments, the second computing device recalculates the resolution in response to a change of the scenario. The change of the scenario can be determined based on the scenario information. If the scenario remains unchanged, there is no need to calculate the new resolution. In some other embodiments, the calculated image resolution is negatively related to the maintenance time of the same scene, that is, the longer the same scenario does not change, the lower the calculated image resolution. In a same scenario, the document can also gradually determine the image resolution, that is, over time, the calculated image resolution gradually changes from high resolution to low resolution. For example, in the same scenario, the calculated image resolution is reduced every predetermined period, such as reducing the image resolution to the next level.

Step S440, in response to the resolution being zero, set a data segment of a data packet corresponding to the image collection device to be transmitted subsequently to be null.

In some embodiments, step S440 further comprises: in response to the resolution not being zero, the first computing equipment adjusts a compressed image corresponding to the image collection device to be transmitted subsequently to the determined resolution. This corresponds to the case where the first computing equipment acts as a main body to adjust the image resolution. For example, if the resolution of the camera 1 is 2k, the first computing equipment 210 adjusts the resolution of the compressed image of the camera 1 to be 2k, and packages the compressed image of 2k into a plurality of data packets. In some embodiments, step S440 further comprises: the second computing equipment adjusting the resolution of the received compressed image corresponding to the image collection device in response to the resolution not being zero. This corresponds to the case where the second computing equipment acts as the main body to adjust the image resolution.

In some embodiments, the first computing equipment performs camera cutoff based on performing frame extraction on a received image sequence. Camera cutoff here means that in some scenarios no camera data is needed, and then this channel or a plurality of channels of camera data will not be transmitted to a server, further saving network resources. For example, in a high-speed scenario, the algorithm module may not compute the data of the cameras in the left and right directions, a backward camera is relied on for left-right lane object detection, or only each camera in the left and right directions is relied on for computations. This not only saves network resources but also reduces algorithm computation. When the resolution of the compressed image required to be transmitted by a certain camera is set as 0, it is not that the camera is shutdown so that it does not collect an image, and it is not that the images collected by the camera are completely discarded by means of 0 frame extraction per P frames; instead, on the basis of 1 frame extraction per P frames, the extracted data packet data segment of the fame image data is set as null. That is, the first computing equipment normally receives and transmits data, except that null data is transmitted. In this way, the normal image acquisition frequency of the camera and the normal image frame extraction frequency and transmission frequency of the first computing equipment are ensured, so as to prevent the data delay and inaccuracy caused by frequently switching the camera on and off, and also prevent the system from misjudgments, which cause frame errors, frame dropping, and like circumstances, due to changing the image frame extraction frequency.

In some embodiments, the first computing equipment 210 may also change the resolution of only certain regions in the image while leaving the resolution of other regions unchanged; or the second computing equipment cuts out the region of interest from the received original image and adjusts the resolution of the region of interest.

In particular, the message further comprises a region of interest determined by the second computing equipment according to the scenario information, the method 400 may further comprise the steps as follows: the first computing equipment 210 receives the message comprising a region of interest determined by the second computing equipment according to the scenario information; determines a target image containing the region of interest from a compressed image to be transmitted subsequently; and adjusts the resolution of the region of interest portion in the target image. The region of interest is represented by the coordinates of the length, width, and key points, such as the length, width, and center point coordinates (or a vertex coordinate). If the second computing equipment needs to focus on viewing the image of the region of interest A, an expression of the region of interest is sent to the first computing equipment. After receiving the region of interest, the first computing equipment identifies a compressed image containing the region of interest, and adjusts the resolution of the region of interest in the compressed image to a required resolution. Alternatively, the second computing equipment directly adjusts the image resolution, i.e., the image processing module cuts out the region of interest from the compressed image and adjusts the resolution of the region of interest.

In some embodiments, the first computing equipment is configured for: acquiring original images collected by the an image collection device; compressing the original images to obtain compressed images; packaging one of the compressed images into at least one data packet each comprising a protocol head and a data segment; sending the at least one data packet to the a second computing equipment; receiving a message comprising a determined resolution corresponding to the image collection device, the resolution being determined by the second computing equipment according to scenario information of a scenario when the original images are collected; and in response to the determined resolution being less than a threshold, setting a data segment of a data packet of the other ones of the compressed images of corresponding to the image collection device to be transmitted subsequently to be null, which comprising: packaging the other ones of the compressed images into data packets each comprising a protocol head and a null data segment, or deleting the existing context of the data segment of a data packet.

In some embodiments, the method further comprises: in response to the resolution being equal or less than a threshold, set a data segment of a data packet corresponding to the image collection device to be transmitted subsequently to be null; and in response to the resolution larger than a threshold, the first computing equipment adjusts a compressed image corresponding to the image collection device to be transmitted subsequently to the determined resolution. The threshold in this document can be set as required, such as 0k. In some embodiments, the threshold in this document can also be other values, such as 1k or 2k, the document is not limited to this.

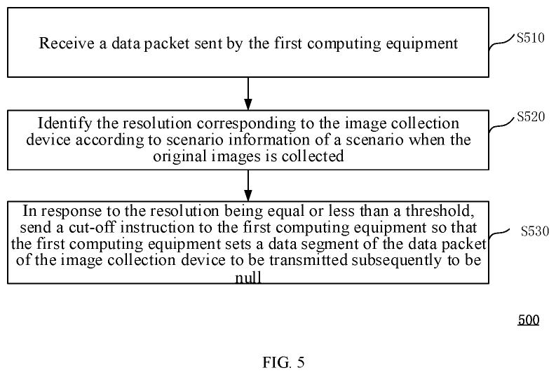

FIG. 5 shows a flowchart of a data transmission method 500 according to another embodiment of the present document, which is applied to be executed by second computing equipment. As shown in FIG. 5, the method 500 includes:
step S510, receiving a data packet sent by first computing equipment, wherein the data packet is obtained by packaging a compressed image, and the compressed image is obtained by compressing a respective original image collected by an image collection device;
step S520, identifying the resolution of a subsequent compressed image corresponding to the image collection device according to scenario information when the respective original image is collected;
and step S530, in response to the resolution being equal or less than a threshold, sending a cut-off instruction to the first computing equipment so that the first computing equipment sets a data segment of a data packet of the image collection device to be transmitted subsequently to be null. In some embodiments, step S530 may further comprise: in response to the resolution being zero, sending a cut-off instruction to the first computing equipment so that the first computing equipment sets a data segment of a data packet of the image collection device to be transmitted subsequently to be null.

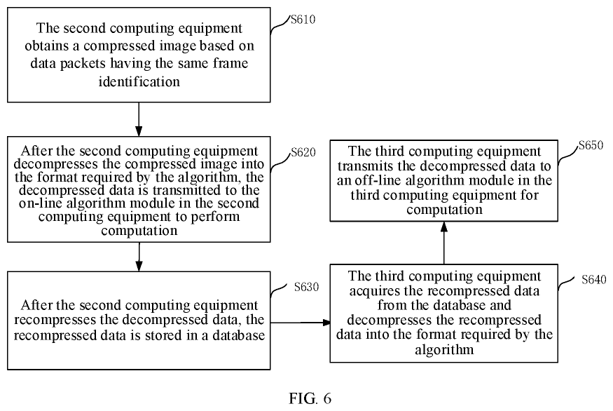

In some embodiments, step S530 may further comprise: in response to the resolution equal or larger than threshold (such as the resolution not being zero), the second computing equipment sending a resolution adjusting instruction to the first computing equipment so that the first computing equipment adjusts the resolution of the compressed image of the image collection device to be transmitted subsequently. Alternatively, the image processing module of the second computing equipment adjusts the resolution of the received compressed image in response to the resolution larger than threshold. Further, the image processing module of the second computing equipment adjusts the resolution of the received compressed image in response to the resolution not being zero. In still some embodiments, the second computing equipment, in response to decompressing the received image, can also store the decompressed data for subsequent off-line algorithm modules to invoke the data for computation. Specifically, as shown in FIG. 6, the data transmission method of the present document may further comprise the steps:
S610: the second computing equipment obtaining a compressed image based on data packets having the same frame identification; and
S620: after the second computing equipment decompresses the compressed image into a specific format (such as a format required by an algorithm module) such as a blue-green-red BGR8 format), the second computing equipment transmitting the decompressed data to an on-line algorithm module (namely, an algorithm module 224) in the second computing equipment for computation. Or, the on-line algorithm module can also access or call the decompressed data decompressed by the second computing equipment. Here, the second computing equipment further performs rotation processing on the restored image according to the pose of the image collection device when the original image is collected.
S630: after the second computing equipment recompresses the decompressed data, the recompressed data is stored in the database.
S40: third computing equipment acquires the recompressed data from the database and decompresses the recompressed data into the format required by the algorithm.
S650: the third computing equipment transmits the decompressed data to an off-line algorithm module in the third computing equipment for computation.

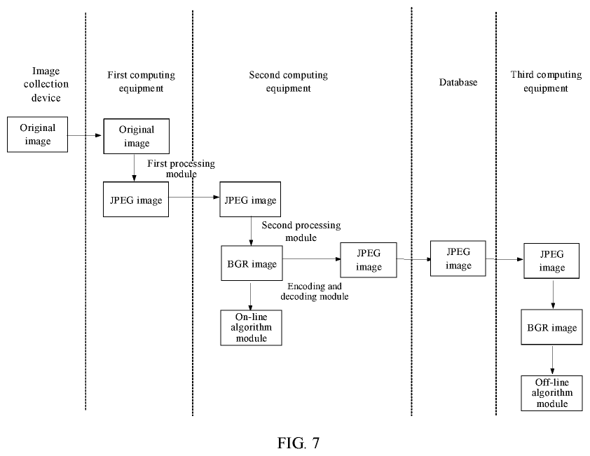

As shown in FIG. 7, after the second computing equipment processes the JPEG image into a BGR format, namely, an image in a specific format required by an algorithm module, on the one hand, the processed BGR image is transmitted to an on-line algorithm module for computation, and on the other hand, the processed BGR image is compressed, and the compressed JPEG image is stored in a database. After that, the third computing equipment acquires the stored JPEG image from the database, decompresses the same into a BGR image, and then transmits the decompressed image to the off-line algorithm module for computation. Or, the off-line algorithm module can also access or call the decompressed image decompressed by the third computing equipment. The third computing equipment serves as remote equipment different from the first computing equipment and second computing equipment, and an off-line algorithm module is resident in it. The off-line algorithm module may be an off-line computer, a computer cluster, etc. for training the algorithm module.

In this way, the BGR image decompressed by the JPEG is transmitted to the on-line algorithm module on the vehicle, and the BGR image decompressed by the JPEG image is also transmitted to the remote off-line algorithm module, so as to ensure the consistency of data input of the same algorithm module when the same algorithm module is used as the on-line algorithm module and the off-line algorithm module respectively, thereby improving the computation consistency of the two kinds of algorithm modules. It should be understood that if the data source input by the off-line algorithm module deviates from the on-line algorithm module by a large amount, the actual application of the algorithm module on a vehicle may be affected. It can be effectively avoided by means of the present document that the training results of the off-line algorithm module cannot be fully applied to the on-line algorithm module.

In some embodiments, step S610 specifically includes: a second receiving module 222 of the second computing equipment 220 obtaining a compressed image based on data packets having the same frame identification. Step S620 specifically includes steps as follows: the second processing module 223 of the second computing equipment 220 decompresses the obtained compressed image into a specific format required by an algorithm module, on the one hand, transmits the decompressed data to an on-line algorithm module for computation, and on the other hand, transmits the decompressed data to a codec (not shown in the figure) of the second computing equipment. Specifically, the second processing module 223 parses the JPEG frame header and performs Huffman decoding, inverse quantization, DCT inverse transformation, color space restoration YUV444, conversion RGB, and also supports image scaling, flipping, resolution switching, etc. Step S530 specifically includes steps as follows: after the codec recompresses the decompressed data, the recompressed data is stored in the database so that the third computing equipment acquires the data in the database to train its off-line algorithm.

As previously mentioned, the adjustment of the image resolution may also be performed by the second computing equipment, i.e., the data decompression operation and the resolution adjustment operation are integrated into one piece of equipment for execution. The second computing equipment 220 can be equipped with one camera driver, which includes a second control module 221 and a second processing module 223. The second processing module 223 may perform at least one of a scaling operation, a rotation operation, a resolution adjustment, or like operations in addition to data decompression. At this point, the first computing equipment 210 normally sends the data to be transmitted to the second computing equipment 220. After receiving the data, the second computing equipment 220 adjusts the received image resolution according to the resolution determined by the algorithm module 224, so that the algorithm module can perform positioning, perceiving, planning, control, and like computations according to the data after adjusting the resolution, thereby reducing the amount of data computation.

According to the technical solutions of the present document, the resolution of an image to be transmitted can be adaptively adjusted according to needs, only transmitting an image of a specific resolution and a specific region required by an algorithm module, speeding up data acquisition speed, reducing network resource consumption and server resource consumption, and improving system stability. The algorithm module adjusts the image resolution, and implements cut-off and like functions according to the scenarios, so as to minimize the resource occupation, improve the data processing speed, and ensure the safe operation of autonomous driving.

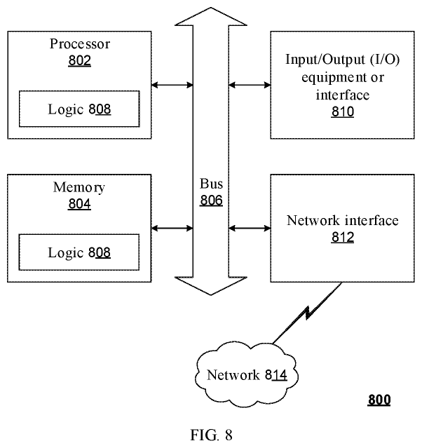

FIG. 8 shows a diagram of a machine in an exemplary form of computing equipment 800, which can be equipment for executing method 400 and method 500. That is, it can be first computing equipment 210, second computing equipment 220, a database, and third computing equipment. The set of instructions within the computing equipment, when executed, and/or the processing logic, when activated, may cause the machine to execute any one or more of the methods described and/or claimed herein. In alternative embodiments, the machine operates as standalone equipment, or may be connected (e.g., networked) to other machines. In a networked deployment, a machine may operate in the identity of a server or a client machine in a server-client network environment, or as a peer in a peer-to-peer (or distributed) network environment. A machine may be a personal computer (PC), a laptop computer, a tablet computing system, a personal digital assistant (PDA), a cellular telephone, a smart phone, a network application, a set-top-box (STB), a network router, a switch or a bridge, or any machine capable of executing a set of instructions that specify actions to be taken by that machine (either sequentially or otherwise), or initiating processing logics. Further, although only a single machine is illustrated, the term “machine” may also be understood to include any collection of machines that individually or jointly execute any one kind of set or a plurality of kinds of sets of instructions (or a plurality of sets of instructions) to execute the methods described and/or claimed herein.

The exemplary computing equipment 800 may include a data processor 802 (e.g., a system on a chip SoC, a general purpose processing core, a graphics core, and optionally other processing logics) and a memory 804 (e.g., internal storage) that may communicate with each other via a bus 806 or other data transfer systems. The computing equipment 800 can also include various input/output (I/O) equipment and/or interfaces 810, such as a touch screen display, an audio jack, a voice interface, and an optional network interface 812. In an exemplary embodiment, network interface 812 may include one or more radio transceivers configured to be with any one or more standard wireless and/or cellular protocols or access technologies (e.g. the second-generation (2G), 2.5-generation, the third-generation (3G), the fourth-generation (4G), and the next-generation radio access for cellular systems, Global System for Mobile Communications (GSM), General Packet Radio Service (GPRS), Enhanced Data GSM Environment (EDGE), Wideband Code Division A plurality of Access (WCDMA), LTE, CDMA2000, WLAN, Wireless Router (WR) mesh, etc.). The network interface 812 may also be configured to be used with various other wired and/or wireless communication protocols including TCP/IP, UDP, SIP, SMS, RTP, WAP, CDMA, TDMA, UMTS, UWB, WiFi, WiMax, Bluetooth, IEEE802.11x, etc. In essence, the network interface 812 an actually include or support any wired and/or wireless communication and data processing mechanism. Through the mechanism, information/data can be propagated between the computing equipment 800 and another computing or communication system through a network 814.

The memory 804 can represent a machine-readable medium (or computer-readable storage medium) on which one or more sets of instructions, software, firmware, or other processing logics (e.g., logic 808) that implements any one or more of the methods or functions described and/or claimed herein are stored. The logic 808, or a portion thereof, may also be wholly or at least partially provided within a processor 802 during the execution by the computing equipment 800. As such, the memory 804 and processor 802 may also constitute a machine-readable medium (or computer-readable storage medium). The logic 808 or a portion thereof may also be configured as processing logic or logic. At least a portion of the processing logic or logic is partially implemented in hardware. The logic 808 or a portion thereof may also be transmitted or received over the network 814 via the network interface 812. Although the machine-readable medium (or computer-readable storage medium) of the exemplary embodiments may be a single medium, the term “machine-readable medium” (or computer-readable storage medium) should be taken to include a single non-transitory medium or a plurality of non-transitory media (e.g., a centralized or distributed database and/or an associated cache and computing system) storing one or more sets of instructions. The term “machine-readable medium” (or computer-readable storage medium) may also be taken to include any non-transitory medium that is capable of storing, encoding, or carrying a set of instructions for the execution by a machine to cause the machine to perform any one or more of the methods of the various embodiments, or that is capable of storing, encoding, or carrying data structures utilized by or associated with such a set of instructions. The term “machine-readable medium” (or computer-readable storage medium) can thus be interpreted to include, but is not limited to, solid-state memories, optical media, and magnetic media.

The disclosed and other embodiments, modules, and functional operations described herein may be implemented in fundamental digital circuit systems, or in computer software, firmware, or hardware (including structures disclosed herein and their structural equivalents), or in combinations of one or more of them. The disclosed and other embodiments may be implemented as one or more computer program products, that is, one or more modules of computer program instructions encoded on a computer-readable medium for the execution by, or to control the operation of, a data processing device. The computer-readable medium can be machine-readable storage equipment, a machine-readable storage substrate, memory equipment, a composition of matter affecting a machine-readable propagated signal, or a combination of one or more of them. The term “data processing device” encompasses all devices, equipment, and machines for processing data, including, for example, a programmable processor, a computer, or a plurality of processors or computers. In addition to hardware, the device can further include codes that create an execution environment for the computer program in question, such as a code that constitutes a processor firmware, a protocol stack, a database management system, an operating system, or a combination of one or more of them. A propagated signal is an artificially generated signal, such as an electrical, optical, or electromagnetic signal generated by a machine. The signal is generated to encode information to be transmitted to a suitable receiver device.

A computer program (also referred to as a program, software, software application, script, or code) can be written in any form of programming language (including compiled or interpreted languages). The computer program can be deployed in any form, including as a stand-alone program or as a module, component, subroutine, or another unit suitable to be used in a computing environment. The computer program does not necessarily correspond to a file in a file system. A program may be stored in a portion of a file that holds other programs or data (e.g., one or more scripts stored in a markup language document), or in a single file dedicated to the program in question, or in a plurality of collaboration files (e.g., files that store one or more modules, subroutines, or a portion of codes). The computer program can be deployed to be executed on one computer, or on a plurality of computers that are located at one site or distributed across a plurality of sites and interconnected by a communication network.

The processes and logic flows described in this document may be executed by one or more programmable processors executing one or more computer programs to perform functions by operating on input data and generating the output. The process and logic flow can also be executed by dedicated logic circuit systems (such as FPGA (Field Programmable Gate Array) or ASIC (Application Specific Integrated Circuit)), and the device can also be implemented as a dedicated logic circuit (such as FPGA (Field Programmable Gate Array) or ASIC (Application Specific Integrated Circuit)).

Processors suitable for the execution of a computer program include, by way of example, both general purpose microprocessor and special purpose microprocessor, and any one or more processors of any kind of digital computers. Generally, a processor will receive instructions and data from a read-only memory or a random access memory or both. The essential elements of a computer are a processor for executing instructions and one or more pieces of memory equipment for storing instructions and data. Typically, computers may also include one or more pieces of mass storage equipment (such as magnetic disks, magnetooptical disks, or optical disks) for storing data, or computers may be operatively coupled to receive data from or transfer data to one or more pieces of mass storage equipment, or perform both operations. However, a computer need not have such equipment. Computer-readable media suitable for storing computer program instructions and data include all forms of non-volatile memories, media, and memory equipment, including by way of example semiconductor memory equipment, such as EPROM, EEPROM, and flash memory equipment; magnetic disks, such as an internal hard disk or a removable disk; magnetooptical disks; and CD-ROM disks and DVD-ROM disks. The processor and memory may be supplemented by, or incorporated into, a special purpose logic circuit system.

While this document contains many details, these details should not be construed as limitations on the scope of any of the document or what may be claimed, but rather as descriptions of features that may be specific to particular embodiments of the document. Certain features that are described in this document in the context of separate embodiments can also be implemented in combination in a single embodiment. Conversely, various features that are described in the context of a single embodiment can also be implemented in a plurality of embodiments separately or in any suitable sub-combination. Furthermore, although features may be described above as acting in certain combinations and may even be claimed initially or as such, one or more features from a claimed combination may be omitted from the combination in some cases, and the claimed combination may be directed to a sub-combination or variation of a sub-combination.

Similarly, while operations are depicted in the drawings in a particular order, it should not be understood that such operations need to be performed in the particular order shown, or in sequential order, or that all illustrated operations need to be performed to achieve a desired result. Moreover, the separation of various system components in the embodiments described in this document should not be understood as requiring such separation in all embodiments.

Only some implementations and examples are described, and other implementations, enhancements, and variations may be made based on what is described and illustrated in this document.

The description of the embodiments described herein is intended to provide a general understanding of the structure of various embodiments, and they are not intended to serve as a complete description of all the elements and features of the components and systems that might make use of the structures described herein. Many other embodiments will be apparent to those of ordinary skill in the art upon reviewing the description provided herein. Other embodiments may be utilized and obtained such that structural and logical substitutions and changes may be made without departing from the scope of the present document. The figures herein are merely representative and may not be drawn to scale. Some proportions may be increased while others may be minimized. The description and drawings are, accordingly, to be regarded in an illustrative rather than a restrictive sense.

Some embodiments implement functions in two or more particular interconnected hardware modules or equipment. Related control and data signals are communicated between and through the modules, or as part of an application-specific integrated circuit. Therefore, the exemplary system is suitable for software, firmware, and hardware implementations.

Although exemplary embodiments or examples of the present document have been described with reference to the accompanying drawings, it should be understood that the above exemplary discussion is not intended to be exhaustive or to limit the document to the precise forms disclosed. Many modifications and variations are possible in light of the above teaching. Accordingly, the disclosed subject matter should not be limited to any single embodiment or example described herein, but rather should be construed in breadth and scope in accordance with the appended claims.

What is claimed is:

1. A data transmission method comprising:
acquiring, by a first computing equipment, original images collected by an image collection device;
compressing, by the first computing equipment, the original images to obtain compressed images;
packaging, by the first computing equipment, one of the compressed images into at least one data packet each comprising a protocol head and a data segment;
sending, by the first computing equipment, the at least one data packet to a second computing equipment, so that the second computing equipment determines a resolution corresponding to the image collection device according to scenario information of a scenario when the original images are collected; and
in response to the determined resolution being equal or less than a threshold, setting, by the first computing equipment, a data segment of a data packet of other ones of the compressed images corresponding to the image collection device to be null.

2. The method of claim 1, wherein setting, by the first computing equipment, the data segment of the data packet of the other ones of the compressed images corresponding to the image collection device to be null comprises:
packaging, by the first computing equipment, the other ones of the compressed images into data packets each comprising a protocol head and a null data segment.

3. The method of claim 1, wherein the at least one data packet further comprises a region of interest determined by the second computing equipment according to the scenario information, and the method further comprising:
determining, by the first computing equipment, a target image containing the region of interest from the other ones of the compressed images; and
adjusting, by the first computing equipment, a resolution of the region of interest in the target image to the determined resolution.

4. The method of claim 1, wherein:
each protocol head comprises at least one of a packet sequence number, a timestamp of a respective original image, or a frame identification of a respective original image;
the scenario information comprises a scenario type, and the scenario type comprises at least one of an expressway scenario, a level road scenario, a reversing scenario, an uphill scenario, a port scenario, or a calibration scenario.

5. The method of claim 1, wherein packaging, by the first computing equipment, one of the compressed images into the at least one data packet comprises:
packaging, by the first computing equipment, a predetermined number of rows of pixels of the one of the compressed images into a data packet, wherein the protocol head comprises a row identification of the row.

6. The method of claim 1, further comprising:
configuring, by the first computing equipment, a parameter of the image collection device; and
sending, by the first computing equipment, the parameter to the image collection device;
wherein the parameter comprises at least one of a frame rate, an output format, an exposure time, or a gain.

7. The method of claim 1, acquiring, by the first computing equipment, the original images collected by the image collection device comprising:
sending, by the first computing equipment, a trigger signal to the image collection device;
receiving, by the first computing equipment, an image sequence, which is collected by the image collection device in response to the trigger signal; and
performing, by the first computing equipment, frame extraction process on the image sequence every predetermined number of frames to obtain the original images.

8. The method of claim 1, further comprising at least one of:
in response to the determined resolution being larger than the threshold, adjusting, by the first computing equipment, a resolution of the other ones of the compressed images corresponding to the image collection device to the determined resolution; or
in response to the determined resolution being larger than the threshold, adjusting, by the second computing equipment, a resolution of the other ones of the compressed images received corresponding to the image collection device to the determined resolution.

9. The method of claim 1, further comprising at least one of:
identifying, by the second computing equipment, the scenario information from a subscribed message topic; or
identifying, by the second computing equipment, the scenario information according to a pose of the image collection device when collecting the original images.

10. The method of claim 1, wherein both the compressed images and the data packet carrying the scenario information.

11. The method of claim 1, further comprising:
decompressing, by the second computing equipment, the data packet to obtain decompressed data;
performing, by the second computing equipment, image rotation processing on the decompressed data according to a pose of the image collection device when the original images are collected.

12. The method of claim 11, further comprising:
determining, by the second computing equipment, each compressed image based on data packets having a same frame identification;
in response to the decompressed data having a specific format, transmitting, by the second computing equipment, the decompressed data to an algorithm module in the second computing equipment for computation; and
in response to the decompressed data having been recompressed, storing, by the second computing equipment, the recompressed data in a database.

13. The method of claim 12, further comprising:
acquiring, by a third computing equipment, the recompressed data from the database;
decompressing, by the third computing equipment, the recompressed data into the specific format; and
transmitting, by the third computing equipment, the decompressed data to an algorithm module in the third computing equipment for computation.

14. The method of claim 12, wherein the image collection device comprises a camera, wherein the original images comprise at least a Bayer image, wherein the specific format is a format required by the algorithm module, and wherein each of the compressed images comprises a JPEG image.

15. A data transmission method comprising:
receiving, by a second computing equipment, a data packet from a first computing equipment, wherein the data packet is obtained by packaging one of compressed images, and each compressed image is obtained by compressing a respective original image of original images collected an image collection device;
determining, by the second computing equipment, a resolution corresponding to the image collection device according to scenario information of a scenario when the original images are collected; and
in response to the determined resolution being equal or less than a threshold, sending, by the second computing equipment, a cut-off instruction to the first computing equipment, so that the first computing equipment sets a data segment of a data packet of other ones of the compressed images corresponding to the image collection device to be null.

16. The method of claim 15, further comprising:
in response to the determined resolution being larger than a threshold, sending, by the second computing equipment, a resolution adjusting instruction to the first computing equipment, so that the first computing equipment adjusts a resolution of the other ones of the compressed images corresponding to the image collection device to the determined resolution.

17. The method of claim 15, wherein the determined resolution comprises at least one of 0k, 1k, 2k, 4k, or 8k.

18. A first computing equipment, comprising:
a processor, a memory, and a computer program stored on the memory and operable on the processor;
wherein the computer program, when operating on the processor, executes a method comprising:
acquiring original images collected by an image collection device;
compressing the original images to obtain compressed images;
packaging one of the compressed images into at least one data packet each comprising a protocol head and a data segment;
sending the at least one data packet to a second computing equipment, so that the second computing equipment determines a resolution corresponding to the image collection device according to scenario information of a scenario when the original images are collected; and
in response to the determined resolution being equal or less than a threshold, setting a data segment of a data packet of other ones of the compressed images corresponding to the image collection device to be null.

19. The first computing equipment of claim 18, wherein the at least one data packet further comprises a region of interest determined by the second computing equipment according to the scenario information, and the method further comprises:
determining a target image containing the region of interest from the other ones of the compressed images; and
adjusting a resolution of the region of interest in the target image to the determined resolution.

20. A non-transitory computer-readable storage medium, storing a computer program thereon, wherein the computer program, when operated by a processor, implements a method of claim 1.
